(19) United States
(12) Patent Application Publication
(10) Pub. No.: US 2008/0295751 A1
(43) Pub. Date: Dec. 4, 2008

(54) PNEUMATICALLY POWERED SEED DELIVERY SYSTEM FOR AGRICULTURAL PLANTER

(75) Inventors: Kenneth E. Shoup, Bonfield, IL (US); Alan F. Barry, Williamsburg, IA (US); Jon E. Kinzenbaw, Williamsburg, IA (US); Kurt W. Olsen, Williamsburg, IA (US)

Correspondence Address: WILDMAN HARROLD ALLEN & DIXON LLP, 225 WEST WACKER DRIVE, SUITE 2800, CHICAGO, IL, 60606, US

(73) Assignee: KINZE MANUFACTURING, INC., Williamsburg, IA (US)

(21) Appl. No.: 12/133,009

(22) Filed: Jun. 4, 2008

Related U.S. Application Data
(60) Provisional application No. 60/941,912, filed on Jun. 4, 2007.

(51) Int. Cl. A01C 7/20; A01C 7/08

(52) U.S. Cl. 111/174

(57) ABSTRACT

A pneumatically powered seed delivery system for an agricultural planter includes an air lock between a main seed hopper and the forced air delivery system. The air lock accurately meters the seed and isolates the interior of the seed hopper from the forced air delivery system. Seed is delivered to individual planter row units, each including an air horn having a buffer reservoir for storing and feeding seed to the associated seed meter under controlled conditions, and a seed routing conduit for carrying seed not deposited in a given seed meter to the other row units downline.

### RELATED APPLICATION

This application claims benefit of the filing date of co-pending provisional application Ser. No. 60/941,912, filed Jun. 4, 2007, entitled “PNEUMATICALLY POWERED SEED DELIVERY SYSTEM FOR AGRICULTURAL PLANTER”.

### FIELD OF THE INVENTION

The present invention relates to a pneumatically powered system for delivering seed to individual row units in an agricultural planter. A centralized, large storage hopper stores the seed for delivery to the individual planter row units which are mounted on the planter frame and plant the seed in individual rows.

### SUMMARY OF THE INVENTION

The system includes a fan or other source for generating pressurized air to convey the seed from the main storage hopper to the seed meters. The seed is introduced from the main seed hopper to delivery conduit or hoses through an improved, multiple outlet air lock device in which the seed is metered out in measured quantity and which prevents the pressurized air which routes the seed, from being introduced into the bottom of the gravity-operated main seed storage hopper. Thus, the air lock device isolates the interior of the main seed hopper from the pressurized distribution conduit, to enable the interior of the main hopper to be maintained at near atmospheric pressure.

The main storage hopper has a funnel shape to direct the seed under gravity to individual air lock devices. By way of example, each air lock device of the illustrated embodiment feeds seed to a group of row units in series, and excess seed is returned to the main hopper. Each air lock device, in turn, may feed seed to a group of separate row units in parallel.

The air lock device mechanically meters and introduces seed into a tubular delivery conduit (typically, a hose). The air source forces air through the seed delivery conduit, causing the seeds to be distributed through the delivery conduit to individual row units in sequence or to a number of row units in parallel, if desired. Preferably, the delivery rate of seed is controlled by driving the air locks with a signal representative of the ground speed of the planter.

In the illustrated embodiment, by way of example, there may be twelve or sixteen rows, arranged into groups of four. Each group of four rows is fed by a single air lock in series, although other arrangements are possible.

Further, the present invention greatly facilities various planting arrangements. Thus, all row units could be mounted to the rear of a planter frame (or tool bar). This might be typical for planting corn at a thirty inch row spacing. However, additional row units could be mounted to the front of the planter frame at the mid-point of the rear units, thus providing a fifteen inch row spacing (or “splitter rows” as they are commonly referred to) for planting beans. The same planter could be used for both corn and beans by shutting off the forward row units to plant corn at thirty inch rows and activating both forward and rear rows to provide a fifteen inch spacing for beans, without physically mounting or removing individual row units. A plunger controls feeding seed to each row unit.

Regardless of the grouping of row units, at each row unit, there is a delivery horn having an advantageous shape, in which the seeds are fed through an internal routing conduit to the row unit seed meters, routing excess seed to a return. The seed is introduced at an upper inlet opening and forced by the pressurized air through a generally circular or U-shaped internal seed routing conduit having, in the illustrated embodiment, an outlet located at a lower elevation than the inlet. The delivery horn also includes a seed delivery or buffer storage reservoir (much smaller, of course, than the main hopper) extending from an intermediate location downstream of the U-shaped internal routing conduit of the delivery horn to a lower, downwardly facing opening which feeds the seed to the inlet of a seed reservoir of a conventional air seed meter, for example, the meter disclosed in U.S. Pat. Nos. 7,093,548 and 7,152,542. Other air seed meters may be used, as well. There are a number of known designs for such meters.

The buffer storage reservoir, is generally upright and preferably has a progressively enlarged cross-section from inlet to outlet, and it serves as a temporary storage reservoir for seed being delivered to the individual seed meter. Under normal operation, seeds are delivered to the buffer storage section until it has reached its capacity (which occurs quickly during start-up). Thereafter, overflow seeds are routed through the return section of the seed routing conduit and thence to another row unit downstream in the system, or back to the main seed storage hopper (if meters are fed in parallel or a particular meter is at the end of a chain of meters being filled serially).

Once the seed buffer reservoir of a row unit is full, the seeds in the buffer reservoirs act as a choke to impede air flow to the meter being fed so that there is a substantial (if not complete) pressure drop between the inlet of the buffer reservoir and the reservoir of the air seed meter. This grouping of temporarily stored or slowly moving (i.e. continuously being depleted and re-filled) seed in the buffer reservoir helps to isolate the inlet of the air seed meter from the pneumatic delivery source so that air entering the seed reservoir of the meter does not substantially affect operation of the seed meter. That is, the buffer reservoir, which is typically filled with seed, acts to isolate the seed reservoir of the meter from the pressurized air in the delivery conduit. Further, a screen is preferably provided in the wall of the seed meter, opening the seed reservoir to the atmosphere, thus neutralizing any positive pressure in the seed reservoir of the meter and maintaining pressure in the meter seed reservoir at atmospheric pressure. Overflow seeds are routed from the outlet of the seed routing conduit to another row unit downline, or returned back to the main seed storage hopper.

Due to the continuous flow of seed in the main delivery conduit, the curved shape of the internal routing conduit, and the location, shape and upright orientation of the buffer storage reservoir in the seed delivery horn, the buffer storage reservoir is replenished with seed continuously as seed is removed and planted, so that the buffer reservoir remains nearly full as long as there is seed available. Moreover, the mass of seeds in the buffer storage section, once it is filled, acts to isolate the pressure in the seed reservoir of the row unit (which is preferably at atmospheric pressure, in the case where the seeds are selected and retained during delivery by suction or “vacuum”), and the seed delivery conduit, which is under positive pressure (to force the seeds in routing).

Another advantage of the instant system is the use of a unique air lock device (or simply “air lock”) for receiving seed from the main seed hopper under gravity and introducing seed into the pressurized main seed delivery conduit while accurately metering the seed for delivery, yet preventing air from flowing in a reverse direction into the outlet of the main seed hopper, which would cause a pressure increase in the main hopper.

Other features and advantages of the present invention will be apparent to those skilled in the art from the following detailed description of the illustrated embodiments, accompanied by the attached drawing wherein identical reference numerals will be used for like parts in the various views.

### BRIEF DESCRIPTION OF THE DRAWING

FIG. 1 is a perspective diagram, partly in schematic form, of an air seed delivery system incorporating the present invention;

FIG. 1A is a top view of the air lock device such as is shown at 12 in FIG. 1;

FIG. 1B is a upper, rear, left side perspective view of the air lock device shown in FIG. 1A;

FIG. 1C is a vertical cross-sectional view, taken in a vertical transverse plane, of the assembled air lock device shown in FIGS. 1, 1A and 1B and the distribution tray 11 of FIG. 1;

FIG. 2 is an upper right, rear perspective of a seed meter and mounted delivery horn;

FIG. 2A is a side view of the air delivery horn of FIG. 2;

FIG. 3 is an upper, rear perspective view of an air lock device with the individual components in laterally exploded relation relative to an axis of rotation;

FIG. 4 is an upper, frontal, left side perspective of a plurality of seed meters, each having an associated seed delivery horn, and showing conduit for delivering seed from the lower outlet of one seed delivery horn to the upper inlet opening of an adjacent, downstream seed delivery horn;

FIG. 5 is a vertical cross-sectional view of the main seed hopper, taken along a line extending in the direction of travel of the planter;

FIG. 6 is an enlarged section view along the same plane as FIG. 5 showing the manner in which the seed return conduit delivers excess seed back into the main hopper; and

FIG. 7A-7B are side views of the meter/air horn combination with the feed adjusting plunger in the open and closed seed delivery positions respectively.

### DETAILED DESCRIPTION OF THE ILLUSTRATED EMBODIMENT

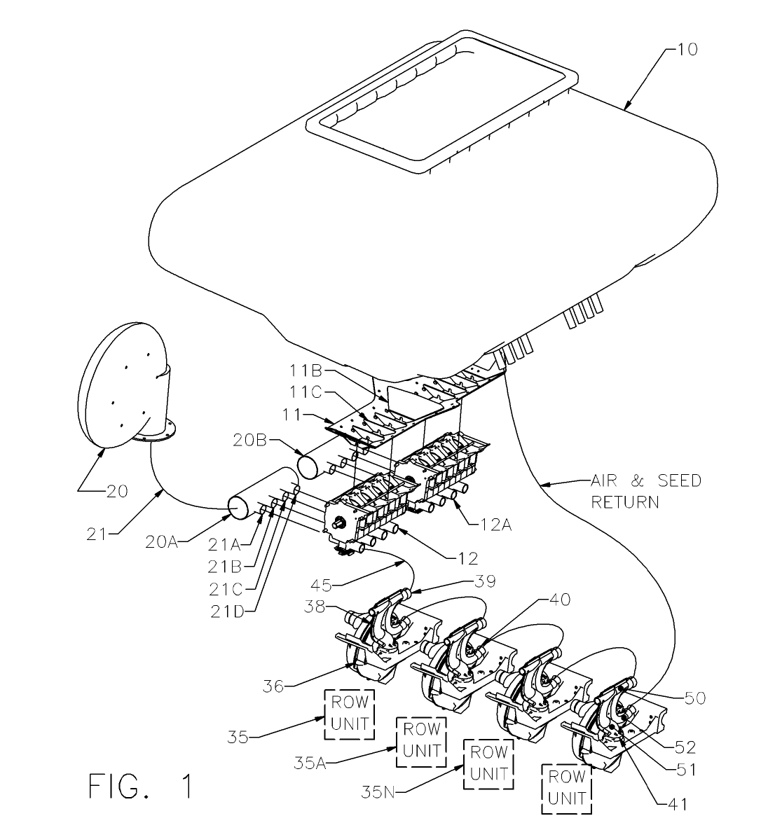

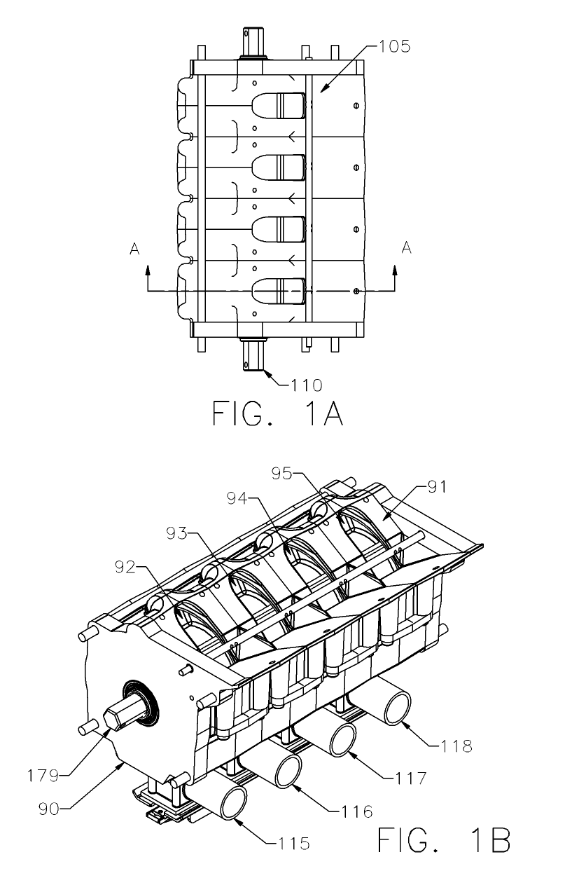

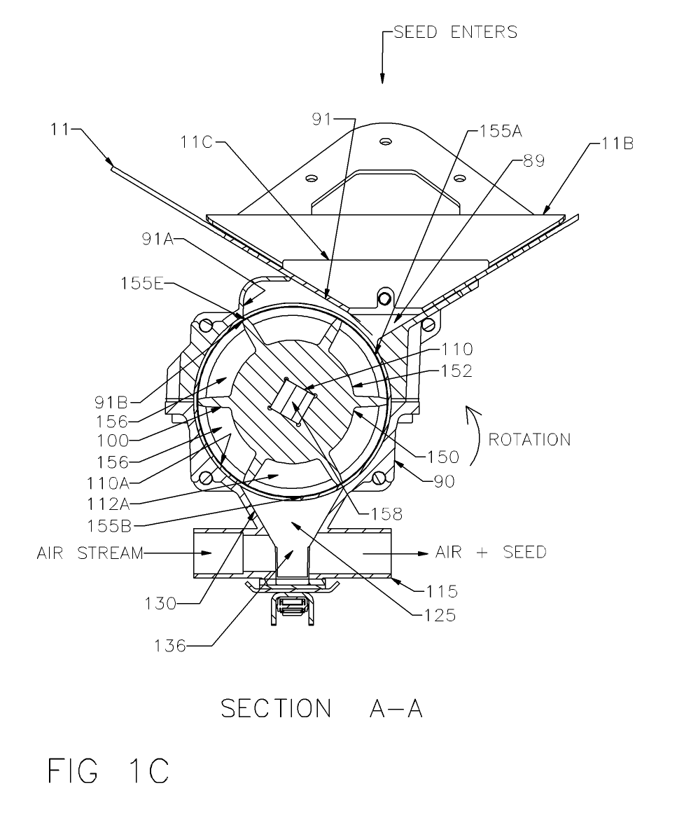

Referring first to FIG. 1, reference numeral 10 designates a central or main seed hopper for an agricultural row crop planter. In FIG. 1, the forward direction of travel is toward the upper left. The hopper 10 stores seed and feeds it through a lower distribution tray 11 (which may be elongated laterally and mounted to the bottom of the hopper housing) under gravity. The seed is delivered directly from the distribution tray 11 to one or more air lock devices 12, 12A. The function of the air lock device 12, as described in more detail below, is to receive and meter seed from the hopper 10 to individual air locks 12, 12A, while isolating the pressure in the seed distribution conduit from the interior of the main seed hopper 10, which is desired to be kept at atmospheric pressure level.

The seed is routed under gravity and introduced in measured quantity into individual sections of the air lock device 12, and then to individual meters, as will be further described below. The seed meters may be air seed meters of the type shown in the above identified patents, but other meters may equally well be used. The seed meters are integral with conventional planter row units schematically represented at 35, 35A . . . 35N. Thus, the seed meters and row units need not be described in further detail for a complete understanding of the instant invention.

The system can be set up such that the air lock device 12 has an individual outlet conduit for each separate air seed meter (i.e. row unit). Alternatively, a similarly constructed air lock device could feed a single conduit, which in turn would feed all the meters sequentially (in series). Alternatively, the air lock device could feed groups of individual air seed meters so that all air seed meters of a given group would be fed in series, as seen in FIG. 1, but all of the groups of meters would be fed in parallel by separate air locks. Thus, persons skilled in the art will fully understand the invention, in all its modifications by understanding one air lock and its associated distribution and usage.

Turning now to the left side of FIG. 1, a fan 20, or other source of pressurized air, forces air through a seed delivery conduit 21 (shown diagrammatically as a line, for simplicity). As explained, the seed delivery conduit could be a single conduit (as illustrated) or a number of separate conduits, all coupled to the same source of pressurized air, or if there are a number of seed delivery conduits, they also could be grouped so that one or more individual seed delivery conduits could be fed by a single source of pressurized air.

For purposes of further explaining FIG. 1, and for simplifying the presentation, it is assumed that the system is arranged such that the total number of row units is divided into groups. For example, there may be four individual row units per group, and there may be more than one group of row units, so that the planter could be a four-row, an eight-row, a twelve-row, or a sixteen-row planter, (or larger), with each group of four rows being fed in parallel (i.e., together), as illustrated. That is, each group of four meters is fed by a separate seed delivery conduit (such as the conduit 45). Any number of arrangements of groups, or row units per group could be provided. One feature of the present invention is the flexibility with which desired systems could be arranged, without substantial increase in costs and with use of standardized, interchangeable sub-assemblies and components.

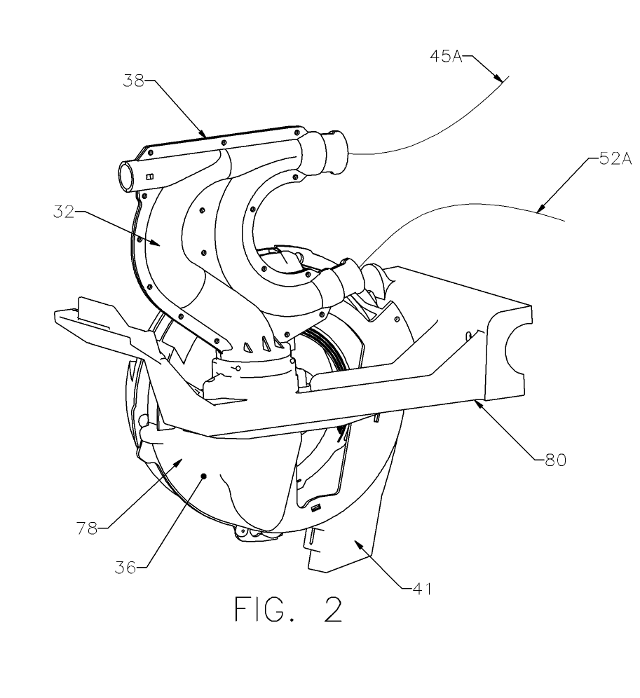

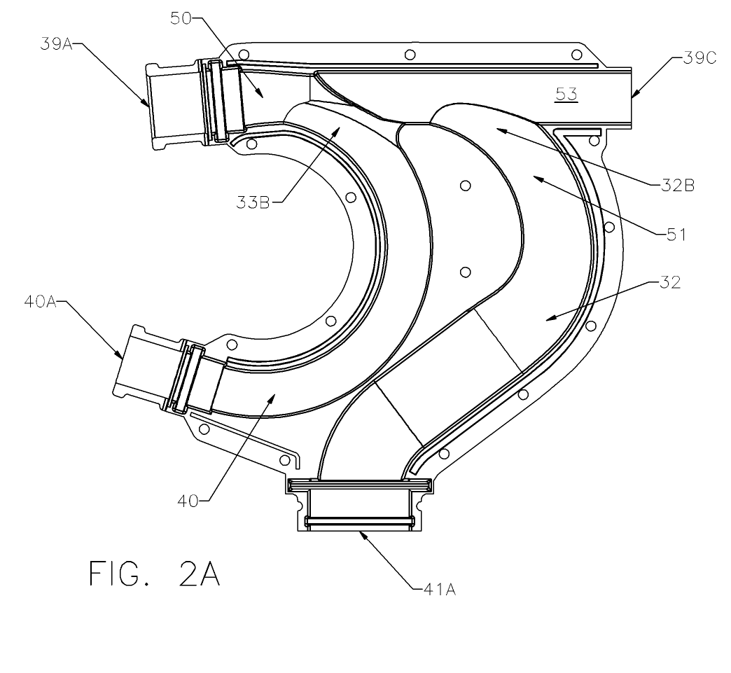

Still referring to FIG. 1, the dashed blocks 35, 35A, 35N represents individual planter row units which may be conventional, each including an air seed meter 36 (FIG. 2) adapted to receive an air delivery horn, such as the one designated 38. The air seed meter 36 may be of the type disclosed in the above-identified U.S. patents. The invention contemplates providing the structure referred to as a seed delivery horn and shown at 38 in FIG. 1, and seen in more detail in FIGS. 2 and 2A. There is a seed delivery horn 38 mounted to and feeding each individual air seed meter 36. In particular, seed is delivered from the seed delivery horn 38 under gravity directly to the seed reservoir of each individual air seed meter 36 (see FIG. 2).

Returning now to FIG. 1, fan 20 feeds a manifold 20A by means of hose or conduit diagrammatically shown at 21. Manifold 20A includes a plurality of outlets 21A, 21B, 21C, 21D, each supplying a group of meters arranged in series and, fed by a single air lock device 12. Manifold section 20A has four outlet ports 21A-21D, each of which is connected to an input of an associated section of the air lock device 12 which is seen in detail in FIGS. 1A-1C. The air source 20 may feed additional manifold sections, such as that designed 20B, as persons skilled in the art will appreciate. The manifold sections may comprise a single, integral conduit feeding pressurized air to all outlets in common. Each manifold section feeds an associated air lock device (see 12A) such as will be described presently, depending on the size of the planter. Each air lock may have a plurality of outlets (four in the illustrated embodiment), and each outlet may feed a plurality of air horns connected in series, if desired and as shown in FIG. 1. In summary, each manifold (20A, 20B) may provide pressurized air to sixteen seed delivery horns.

Turning now to FIGS. 1A, 1B and 1C, reference number 90 (FIG. 1B) designates a housing which is mounted to the distribution tray 11 (FIG. 1) of a large, centralized seed hopper 10 carried on an agricultural planter. The housing 90 includes a V-shaped upper trough designated 91 in FIG. 1B which receives seed from the hopper 10 via the distribution tray 11, and funnels or routes seed from the bottom of the distribution tray 11 of the central hopper 10 under gravity into the inlet troughs of the air locks. FIG. 1C shows the distribution tray 11 in operative relation to an air lock 12.

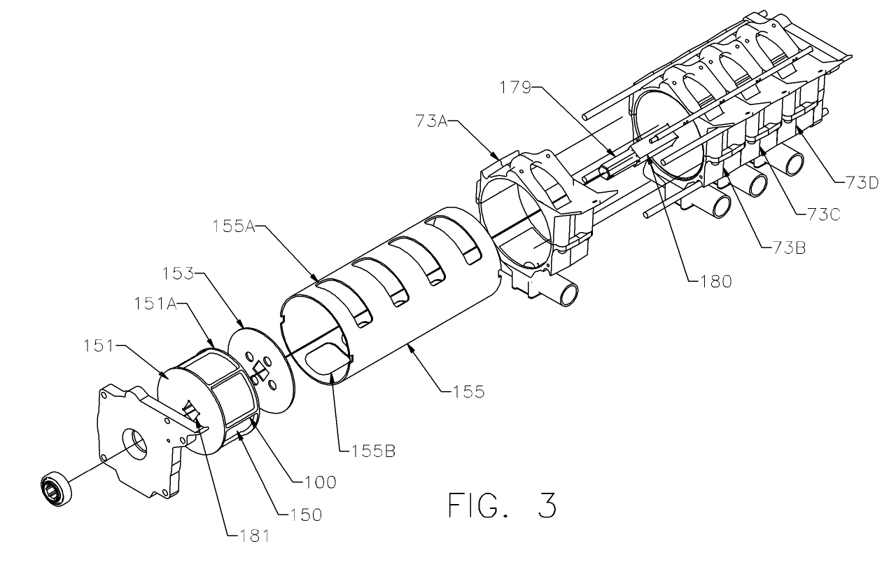

The distribution tray 11 is formed in the shape of a dish or pan which is divided into a delivery section (see separator wall 11 B in the form of an inverted “V” with diverging walls) associated with, and delivering seed to each air lock device 12, 12A, and so on. Further, each air lock is comprised of four separate metering units [73A, 73B, 73C and 73D in FIG. 3]. Each metering unit includes a metering wheel 150 (FIGS. 1C and 3) which includes first and second side walls 151, 151A (FIG. 3), a core 152 (FIG. 1C) and a plurality of radially extending vanes (six in the illustrated embodiment), one being designed 100 in FIGS. 1C and 3. Thus, the vanes and side walls form a number of seed carrying pockets 156.

There is a metering wheel 150 in each metering unit, adjacent metering wheels separated by a spacer 153. All metering wheels are received in a structural cylindrical member 155, referred to as a sleeve and having a circumferentially extending inlet slot (such as the one designated 155A and FIG. 3) for each metering wheel, and an associated generally square outlet slot 155B.

When viewed from the side (as in FIG. 1C), the inlet slot 155A extends from about 60 degrees below top dead center (TDC)—i.e. the vertical or twelve o'clock position to approximately 30 degrees beyond TDC (see 155E in FIG. 1C), however, the inlet for seed ends before top dead center, as will be discussed.

Each metering wheel has its six pockets 156 spaced circumferentially about the axis of rotation 158 defined by the core 152, vanes 100 and sleeve 155. These pockets receive, meter and deliver the seeds to the outlet opening 155B.

As seen in FIG. 1C, the outer edges of the end walls of the pockets (formed by the vanes 100) engage the inner wall of the sleeve 155 and seal against air flow from the discharge opening 155B to the inlet opening 155A. Preferably, at least two such vanes and associated side walls 151, 151A are always in sealing engagement with the inner surface of the sleeve 155 to form the air lock, which isolates the pressure in the seed distribution conduit from the interior of the main hopper 10.

Referring to FIG. 3, a shaft 179 having a generally square drive section 180 extends through corresponding openings (see 181 in FIG. 3) in the metering wheels for driving them and the spacers 153 between adjacent metering wheels rotating within the sleeve 155. The metering units 73A-73D are formed with an upper and a lower section and a lower section mounted together outside the sleeve 155, which aligns all the components, and provides stability and strength to the unit.

In operation, seed is fed into a carrier section or pocket of a metering wheel as it is driven in rotation. The end (i.e. in the direction of rotation) of the inlet opening is formed by the edge 14 of a discharge opening 89 in the distribution tray 11. The discharge opening ends before the TDC position (i.e. seed cannot thereafter be added to fill a pocket). This creates a void at the top of each group of seeds in a metering wheel pocket. This void enables the seed group to adjust (i.e. flow to a lower elevation) within a pocket, and avoid damaging interference with the metering mechanism. In particular, the central parts of the vanes of each wheel re-engage the sleeve 155 at the location designated 155E in FIG. 1C, and the seed, if there is interference with the sleeve or the housing are free to fall back into the void described above, which is created just prior to this point, by the distribution tray and avoid damage to the seed and to the metering mechanism.

The metering wheel 150 and vanes 100 may be formed of resilient, flexible material such as rubber so that the vanes 100 engage the inner surface of the sleeve 155, but yield, to seal against the wall.

With the design shown, the seeds in each of the sectors or carrier pockets of the metering wheel 150 are completely unloaded by the time the trailing vane 100 reaches the position shown in FIG. 1C (for the lowest pocket 112A), and the air being forced through exit conduit 115, for example, transports the seed thus deposited in the space located at the bottom of the opening 125, which space communicates directly with an inlet to the delivery conduit 115, which in turn routes the seed (entrained in the moving air) to delivery conduit 45 of FIG. 1, and thus to the seed meter 36 of row unit 35. Air is prevented (i.e. blocked) from moving upwardly in the air lock with the outer edges of at least two vanes sealing against the inner wall 110A at all times, on either side of center, as seen in FIG. 1C.

It will be appreciated that from FIG. 1C, that the upper half of each metering unit 73A-73D is provided with a vertical wall (see 91A in FIG. 1C) which extends downwardly toward the metering wheel and terminates at a location referred to as a cutoff point 72 at which the extremities of each individual vane 101 passes. This is the point at which excess seeds are removed from a pocket. Wall 91A forms extra space above a pocket to receive seed at the beginning of each seed pocket to permit seed to rise and fall back into a succeeding pocket as a vane passes toward the discharge opening 125. It will be observed that the cutoff point (actually an edge) 72 is located beyond TDC (in the counter-clockwise direction of rotation) in FIG. 1C so that any seed which is adjacent the cutoff position at the time the associated vane traverses the cutoff point and rises above the desired height, will drop down and away from the vane under gravity and into the void in the seed pocket formed during loading that pocket, thereby minimizing the pinching or breaking of seeds at the cutoff point (as well as reducing damage to the vanes). As mentioned, there is room in the pockets for additional seeds because of the void formed due to the location of the downstream edge 106 of the inlet slot 105, which, as discussed above, provides some void space in each seed pocket.

Moreover, as each sector proceeds (counterclockwise) toward the delivery area 125 down at the bottom of FIG. 1C, the seed is routed by the funnel-shape of outlet collar 130 toward the discharge area 136, so that the individual pocket begins to unload as soon as a vane approaches the outlet collar 130, and the pocket is completely unloaded by the time the next succeeding vane reaches the same point. This has provided a reliable and accurate measure of seeds delivered to the conduit feeding the associated delivery horn.

The elongated inlet opening 155A in sleeve 155 for each metering wheel is narrow enough to allow seed from the main hopper to move longitudinally of the multiple output air lock of FIGS. 1A-1C, as the seed passes through larger voids 92-95 and the elongated, narrow inlet opening into the seed pockets. This action prevents the individual sectors from overfilling with seed, and stabilizes the metering of the seed into the individual delivery conduits.

The air lock device not only isolates the interior of the main hopper 10 from the air pressure of the source 20, but the drive shaft (179 in FIG. 1B) (which may be driven in coordination with the ground speed of the planter), provides that the amount of seed being delivered to each seed meter is slightly higher than the planting rate, with excess seed returned to the hopper 10.

Turning to FIG. 2, the air seed meter, generally designated 36, which receives the pneumatically delivered seed, includes a seed inlet at the top of a seed reservoir 78, and a seed outlet or delivery port 41. A mounting frame 80 mounts the seed meter 36 and the seed delivery horn 38 to one another, and the combination to a row unit.

The seed delivery horn 38 is secured to the mounting frame 80 by means of a collar 77 which aligns the output of a seed buffer reservoir 32 which receives seed from the delivering conduit via inlet 45A of the seed delivery horn 38. A seed routing conduit 40 which, as can be seen from FIG. 2A, (which is a right side view) has a generally circular or U-shape extending between the inlet 39 and outlet 40A of the delivery horn, with the plane of the axis (i.e. the U-shape) extending upright (see FIG. 2A as well).

Still referring to FIG. 2A, the bottom or outlet 40A of the seed routing conduit 40 is adapted to be secured to a section of seed conduit (hose) feeding the seed delivery horn of the next row unit in line.

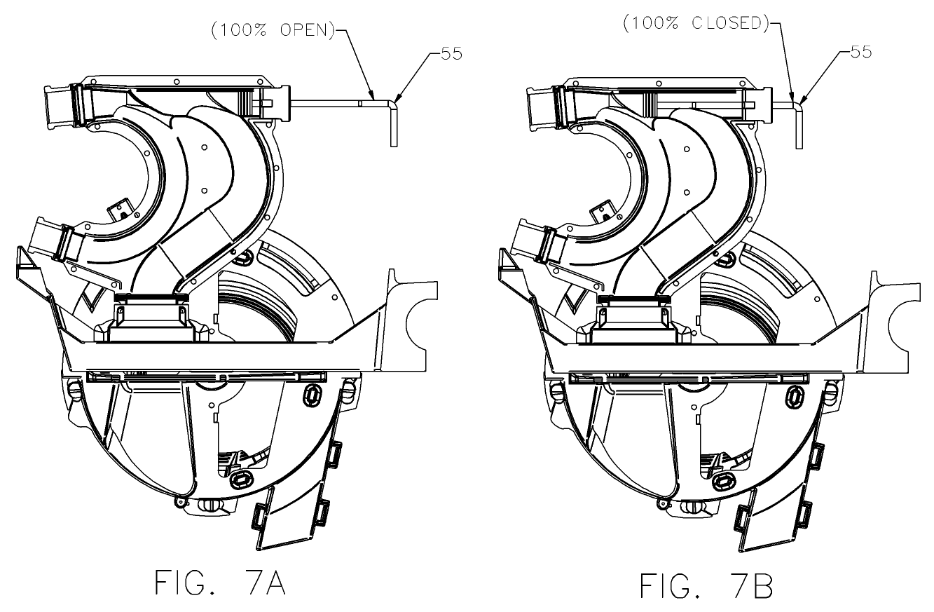

Located in front of the seed routing conduit 40 of the seed delivery horn 38, is the buffer reservoir 32. Above the inlet 33B to the seed routing conduit and the inlet 32B to the buffer reservoir 32, and communicating with both inlets 33B and 32B, is a closed channel 50 which extends from the inlet 39A to the delivery horn to an opening 39C which is adapted to receive a plunger (55 in FIGS. 7A-7B), for adjusting the flow of seed to the buffer reservoir 32.

The buffer reservoir communicates with the inlet 32B (which communicates with the channel 50) with the opening 41A leading to the seed reservoir 78 of the meter 36.

Still referring to FIG. 2A, assuming the opening 39C of the channel 50 is blocked by the adjusting plunger 55, the velocity of the seed received from an inlet delivery conduit carries the seed beyond the inlet opening 33B of the seed routing conduit 33 to the inlet 32A of the seed buffer reservoir 32 which directly feeds the inlet of the main seed reservoir of the meter 36.

Seed is removed from the buffer reservoir as it is planted. The cross-sectional area of the buffer reservoir preferably increases progressively from inlet 32B to outlet 41A to avoid bridging of seed in the buffer reservoir.

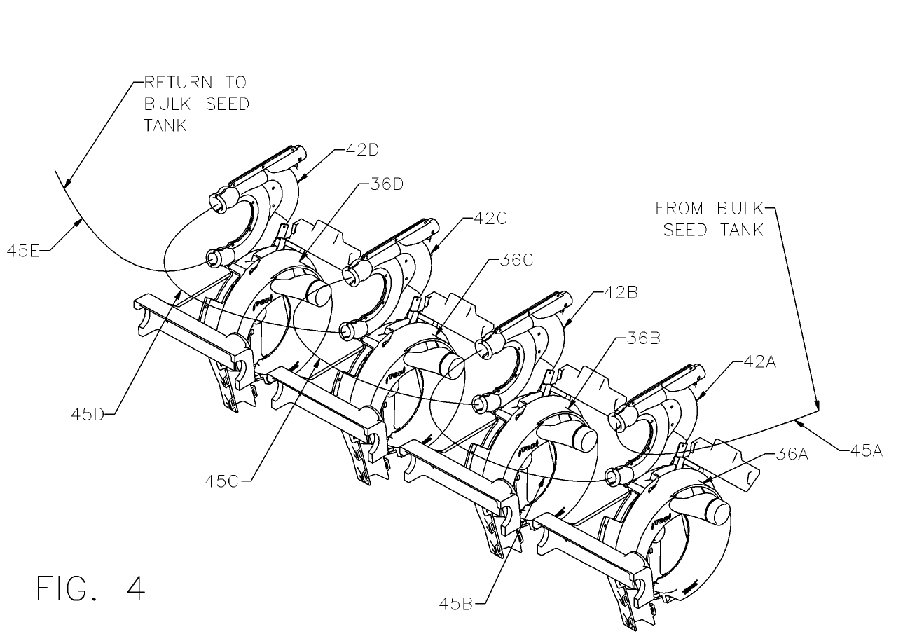

Once the buffer reservoir is full, incoming seed is routed to inlet 33B of the seed routing conduit 40, and thence to the next seed delivery horn in the series, as illustrated in FIG. 4 wherein the seed delivery horns are designated, in order 42A, 42B, 42C and 42D, and the respective meters are designated 36A, 36B, 36C and 36D respectively. The delivery conduit or hose is designated 45A. The hose feeding overflow seed from the first delivery horn 42A to the next delivery horn 42B is designated 45B, and succeeding feed hoses are designated 45C and 45D. The return hose to the seed hopper is designated 45E.

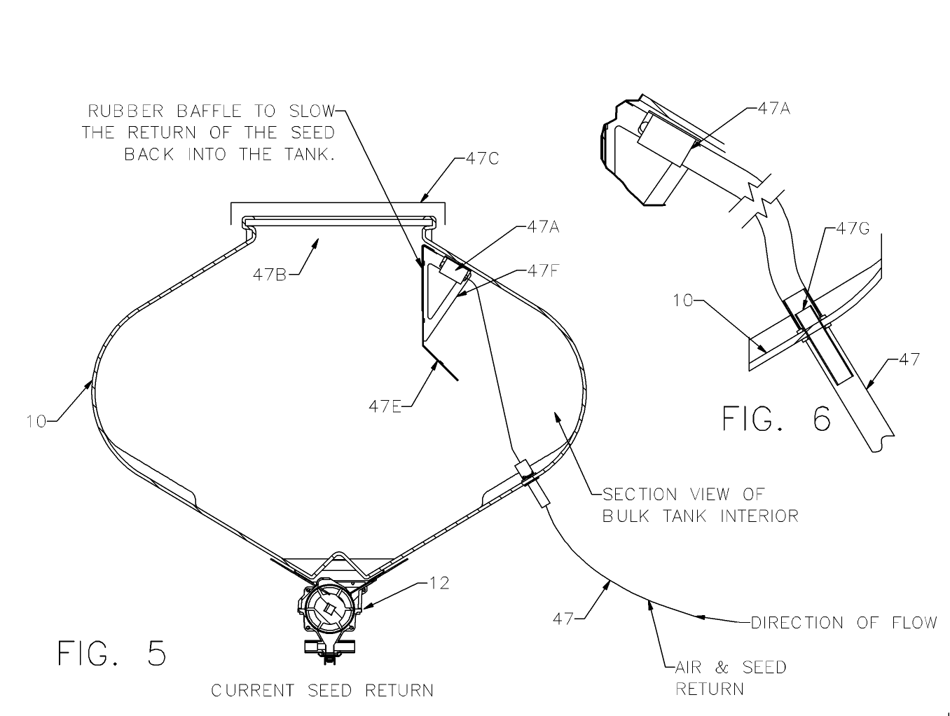

Turning now to FIG. 5, the main seed hopper 10 is shown in a cross-sectional view taken transverse to the axis of the air lock devices 12, and illustrating the return of the seeds to the hopper 10. The final return conduit 47 is fed through a sloping wall of the hopper 10, and the terminal end of the conduit 47 is mounted at 47A to an upper portion of the side wall of the hopper 10 adjacent the hopper inlet 47B. The inlet 47B is provided with a cover 47C which covers the inlet opening but does not provide an airtight seal. Rather, air may escape around the inlet opening of the hopper and down through depending side walls of the cover 47C.

The outlet of the seed return conduit 47 is directed upwardly and into a rubber baffle 47E which drapes downwardly and is supported, when the system is not in operation, by a support 47F.

When the system is in operation and the seed is returned under pressure (that is, both pressurized air and seed are returned), the seed is directed to engage the baffle 47E and comes to rest, and therefore falls onto gravity under the top of the pile of any remaining seed in the hopper.

As the store of seed in the hopper diminishes, the baffle becomes free to move laterally under impact of the driven seed, thereby facilitating a broader distribution of the returning seed to the remaining store of seed.

Turning now to FIG. 6, the return conduit 47 extends through, and is mounted to the wall of the hopper 10, and it is fitted with a tubular extension 47G of reduced cross-sectional area. Conduit 47A is fitted about the reduced tube 47G, thereby providing an enlarged region for reducing the pressure once the seed enters the hopper. Any residual pressure is diminished by the enlarged area within the hopper and the venting of the cover 47C, as discussed. Therefore, the pressure within the hopper 10 may be slightly above atmospheric, but does not affect the accuracy measured distribution of seed from the hopper.

Turning now to FIGS. 7A-7B, a plunger 55 is received in the opening 39 of cylindrical channel 53 of the seed delivery horn 38 (FIG. 2A) and adjusted in the open position in FIG. 7A (i.e. unrestricted delivery to the associated meter 36) and closed in FIG. 7B (i.e. closing the seed delivery hopper, but leaving the seed return conduit open. this permits the operator to control the planting of individual rows (e.g. splitter rows or end rows).

In summary, as seed is delivered from the source to the inlet of a seed delivery horn, if the buffer reservoir is empty, centrifugal force will urge seeds past the inlet 33B of the seed routing conduit 40 into the buffer register 32 (channel 53 being capped if a plunger is not used). As the buffer register fills, eventually the portion of the channel 53 above the buffer reservoir and leading to the inlet 33B of the seed routing conduit 40 will become full. Thereafter, seeds are directed (and carried by the delivery air) into the seed routing conduit 40 and to the next unit in the chain.

To summarize an import aspect, the seed delivery horn 38 includes an inlet section in the form of a channel or conduit designated 50; a seed routing conduit 40; and a buffer reservoir 32, also in the form of a tubular conduit, which extends generally downwardly from the inlet 5 land has a progressively increasing cross-sectional area. The seed routing conduit 40 serves as a smoothly transitioned return conduit for overflow seed after the buffer reservoir is full. As seed is delivered through the inlet section 50, the air pressure and inertia of the seed carries the seed into the inlet 32B buffer reservoir 32 which feeds the seed meter. More seed is delivered to each of the individual delivery horns than the associated seed meter is capable of using. Thus, as seed is delivered into the buffer reservoir 32, it accumulates in the buffer reservoir until the buffer reservoir is filled with seed. The seed then is fed to a successive delivery horn or returned through the seed routing conduit to the reservoir. It will be appreciated that the inertia of the incoming seed will cause it to continue to be directed toward the buffer reservoir, but if the buffer reservoir is full, gravity and air pressure will position the seed toward the routing conduit, and the movement of the pressurized air will carry away excess seed. Moreover, accumulation of seed in the buffer reservoir 32 has the effect of cutting off the flow of air through the buffer reservoir 32.

Having thus disclosed in detail the various embodiments of the present invention, persons skilled in the art will be able to modify certain of what has been disclosed and to substitute equivalent elements for those described; it is, therefore, intended that all such modifications and substitutions be embraced as they are within the spirit and scope of the appended claims.

We claim:

1. An agricultural planter comprising
a hopper for storing seed;
an air lock receiving seed from said hopper and delivering the seed to a stream of air flowing through a seed delivery conduit;
a plurality of row units, each including
a seed meter for planting seed received from said seed delivery conduit; and
a seed delivery horn including a buffer reservoir having an inlet receiving seed from said seed delivery conduit and delivering seed to said meter; and
a seed routing conduit having an inlet upstream of said inlet of said buffer register and directing excess seed to not deliver to said buffer reservoir to a seed return conduit for delivering overflow seed to a succeeding seed delivery horn or to said hopper.
